(19) United States
(12) Patent Application Publication
(10) Pub. No.: US 2010/0114502 A1
(43) Pub. Date: May 6, 2010

(54) SYSTEM AND METHOD FOR ARTICLE MONITORING

(75) Inventors: Vivek V. Badami, Schenectady, NY (US); Vinay Bhaskar Jammu, Bangalore (IN); Scott M. Hoyte, Fountain Inn, SC (US); Eric Gebhardt, Roswell, GA (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/262,783

(22) Filed: Oct. 31, 2008

(51) Int. Cl. G01B 5/28

(52) U.S. Cl. 702/35

(57) ABSTRACT

A system for monitoring a condition of an article comprises a controller; at least one sensor for detecting a characteristic of the article; a signal processor for processing signals from the at least one sensor; a feature extractor that can extract at least one of a range of article conditions from the output from the signal processor and that can evaluate at least one of a range of article conditions, the feature extractor providing feature extractor output to the controller; an operation detector receiving data of detected features of the elements being monitored, the operation detector providing output to the controller; a central system storing historical data about the condition of an article, the off-line processor providing output to the controller. Wherein the controller analyzes the output from the feature extractor, the operation detector, and the central system can provide a system output of the condition of the article.

### BACKGROUND OF THE INVENTION

This invention relates generally to the systems and methods for monitoring conditions of at least one article. In particular, the invention relates generally to the systems and methods for monitoring conditions of blades for turbines. Furthermore, the invention relates generally to the systems and methods for monitoring conditions of gas turbine blades for turbines where the system and methods can detect defects, and predict failures of gas turbine blades using sensors, such as non-contact sensors.

It is known to monitor and determine a condition of a blade, for example of blade tip deflections; using a variety of non-contact sensing technology. Further, these methods and systems may also monitor turbine blade tip vibration using estimation algorithms. In these conventional methods and systems, blade tip deflection magnitudes can be an indication of the blade cracks. The methods and systems can relate blade tip vibrations to high cycle fatigue and potential blade failure.

A single algorithm may not be robust enough by itself to address blade deflection behaviors associated with cracks. Therefore a combination of algorithms may be desired to provide algorithm output signals, or blade health features, into a diagnostic system that uses multiple inputs to build confidence and accuracy in the final estimate of blade health.

### BRIEF DESCRIPTION OF THE INVENTION

A system for monitoring a condition of an article comprises a controller; at least one sensor for detecting a characteristic of the article; a signal processor for processing signals from the at least one sensor; a feature extractor that can extract at least one of a range of article conditions from the output from the signal processor and that can evaluate at least one of a range of article conditions, the feature extractor providing feature extractor output to the controller; an operation detector receiving data of detected features of the elements being monitored, the operation detector providing output to the controller; a central system storing historical data about the condition of an article, the off-line processor providing output to the controller, wherein the controller analyzes the output from the feature extractor, the operation detector and the central system can provide a system output of the condition of the article

A method for monitoring a condition of an article comprises providing a controller; detecting a characteristic of an article; processing signals detected of the characteristic of an article; extracting at least one of a range of article conditions from the output from the processed signal and evaluating at least one of a range of article conditions, providing feature extractor output to the controller; receiving data of detected features of the elements being monitored, the operation detector providing output to the controller; storing historical data about the condition of an article; providing the historical data about the condition of an article and providing the historical data about the condition of an article output to the controller. The method further comprising outputting a condition of the article being monitored.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration and provides an overview of components of a blade health monitoring system, as embodied by the invention;

FIG. 2 is an illustration and overview of the steps involved in blade deflection and feature extraction, as embodied by the invention; and

FIG. 3 is a schematic illustration showing features extracted by diagnostic algorithms to provide levels of diagnostic outputs at progressively increasing levels of specificity, as embodied by the invention.

### DETAILED DESCRIPTION OF THE INVENTION

As used herein, an element or step recited in the singular and proceeded with the word “a,” “an,” or “one” (and especially, “at least one”) should be understood as not excluding plural said elements or steps, unless such exclusion is explicitly stated. Furthermore, references to “one embodiment” (or to “other embodiments”) of the present invention are not intended to be interpreted as excluding either the existence of additional embodiments that also incorporate the recited features or of excluding other features described in conjunction with the present invention. Moreover, unless explicitly stated to the contrary, embodiments “comprising” or “having” an element or a plurality of elements having a particular property may include additional such elements not having that property.

A local data acquisition system, as embodied by the invention, can be capable of reducing the raw blade vibration data by progressively increasing compression ratios, storing more highly granular data around an anomalous change in a blade health feature, and have the capability to upload the data to a remote system for long term monitoring and diagnostics (M&D). Blade features or compressed vibration data from the local data acquisition system can be sent over standard networks to the central system.

Further processing of blade features can be run on the central system to trend key features relating to blade health, as embodied by the invention. These functions include correlation to other related turbine parameters gathered from other turbine monitoring systems and turbine controller, trending individual or combined features to look for meaningful changes with reference to pre-established defect thresholds, and generating alarms for personnel to analyze further and escalation to customers for potential inspections of the turbine. Alarming is accomplished in a variety of ways, including emails, phone calls, and text messages.

The central system, as embodied by the invention, also stores the results of field inspections of turbine blades to update false positive and false negative rates of the blade health diagnostic algorithms, allowing continuous improvement of the blade health monitoring system over time. Risk models are updated based on the field inspections, enabling fine-tuning of turbine inspection intervals and confidence values associated with the M&D system alarms.

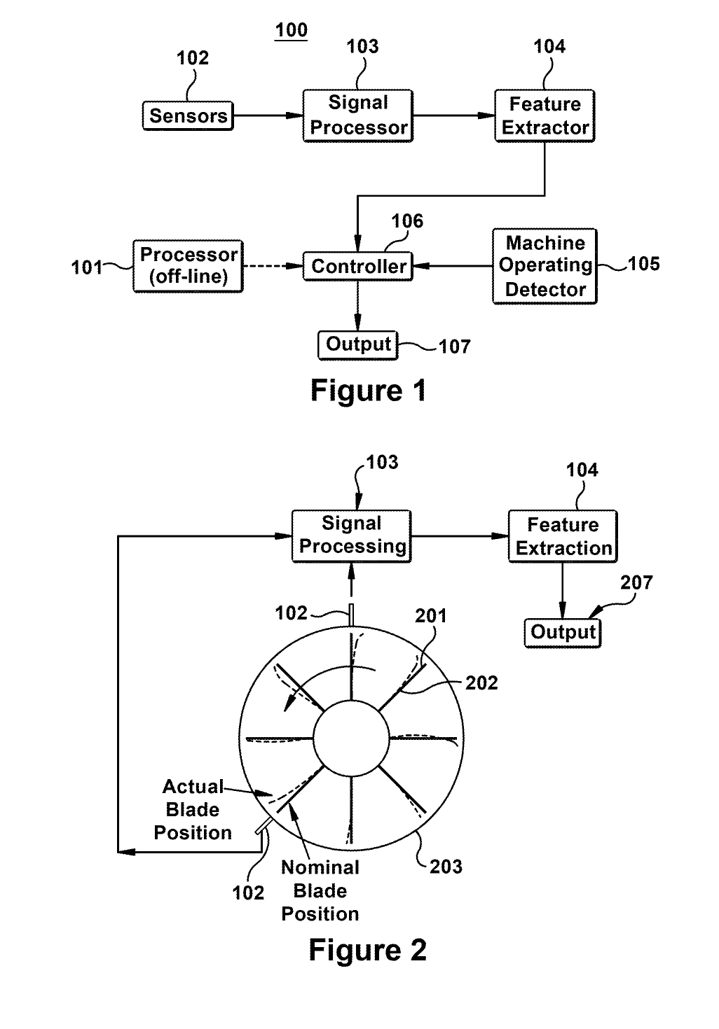

FIG. 1 provides an overview of components of the system for monitoring a condition of an article, for example an element of a piece of rotating equipment, such as but not limited to, an element of a steam turbine, gas turbine or compressor. Examples of such elements include a vane, bucket, airfoil, blade, or other like element. In particular, but not intended to limit the invention, the system for monitoring a condition of an article, as embodied by the invention, can monitor the condition of a blade of a gas turbine.

Accordingly, with respect to FIG. 1, the blade health monitoring system 100, as embodied by the invention, includes an central system or logic 101, which can comprise functions of data archiving, feature fusion, trending, defect alarming, alarm escalation, lifting and risk models, finite element models that are validated via a set of laboratory experiments that can be used to generate expected blade features. The central system or logic 101 can comprise an off-line module. The output of the controller 106, which is typically located at a plant site, is uploaded to the central system or logic 101, via a network connection of any standard form. The output of the controller 106, as embodied by the invention, can be uploaded to the central system 101 via a remote access, as illustrated in FIG. 1 by the broken connection line arrow.

Raw data of at least one characteristic of the article from at least one sensor 102 can be processed in real-time to generate a set of blade features. The at least one sensor 102 may comprise one or more sensors, but in FIG. 2 only one sensor 102 is illustrated for ease of illustration purposes. Each sensor 102, as illustrated, may utilize one or more modalities, such as but not limited to, optical, capacitive, microwave and eddy current to detect and gather information. The sensor 102 signals include, but are not limited to, blade edge time-of-arrival, and blade tip to turbine casing clearance, as described herein after, such as with respect to FIG. 2. Sensor 111 can provide a reference signal at least during every rotation of the turbine shaft, which is required for the processing of blade vibration data, although other frequencies of reference signal provision is within the scope of the invention.

A logic or signal processor 103 (hereinafter “signal processor”) then processes the signal(s) from sensor 102. The signal processor 103, as embodied by the invention, can be provided as any conventional processor. For example, and in no way limiting of the invention, the signal processor 103 may comprise any appropriate high-powered solid-state switching device. As illustrated, the signal processor 103 can be a computer. However, this is merely exemplary of an appropriate high-powered signal processor, which is within the scope of the invention. For example but not limiting of the invention, the signal processor 103 can be implemented as a single special purpose integrated circuit, such as an ASIC, having a main or central processor section for overall, system-level control, and separate sections dedicated performing various different specific combinations, functions and other processes under control of the central processor section. It will be appreciated by those skilled in the art that the signal processor 103 can also be implemented using a variety of separate dedicated or programmable integrated or other electronic circuits or devices, such as hardwired electronic or logic circuits including discrete element circuits or programmable logic devices, such as PLDs, PALs, PLAs or the like. The signal processor 103 can also be implemented using a suitably programmed general-purpose computer, such as a microprocessor or microcontrol, or other processor device, such as a CPU or MPU, either alone or in conjunction with one or more peripheral data and signal processing devices. In general, any device or similar devices on which a finite state machine capable of implementing the flow charts, can be used as the signal processor 103. A distributed processing architecture can be provided for enhanced data/signal processing capability and speed.

The signal processor 103 can process signal(s) from one or more of the sensors 102 both in time and frequency domains. Therefore, the signal processor 103, as embodied by the invention, then sends its output to a feature extractor 104. The feature extractor 104 can extract at least one of a range of article conditions, such as but not limited to, a range of blade features from the output from the signal processor 103 and can also evaluate at least one of a range of article conditions. These features from the feature extractor 104 comprise, but are not limited to, features such as static blade tip bending, blade untwist, blade radial extension, and blade tip vibratory amplitudes and frequencies.

These exemplary features from the feature extractor 104 can then be sent to a controller 106. Additionally, the controller 106 can receive output or signals from a machine operating state detector 105 that detects operating characteristics of the machine or element being monitored, such as speed, load, and other miscellaneous pressures and temperatures associated with a gas turbine. The output or signals from the state detector 105 and from the feature extractor 104 can be used for diagnostics and prognostics of detected features of the elements being monitored. The system output or signals at output 107 from the controller 106 can be used in a variety of ways, such as but are not limited to, model-free trending features over time, and model-based comparison of actual features to expected monitored signatures. The system output 107, as embodied by the invention, can provide output provided in a hierarchical output from simple to complex output, as described hereinafter.

The controller 106 can comprise any appropriate solid-state switching device. As embodied by the invention, the controller 106 can be a computer. In the illustrated embodiment, controller 106 can be implemented as a single special purpose integrated circuit, such as ASIC, having a main or central processor section for overall, system-level control, and separate sections dedicated performing various different specific combinations, functions and other processes under control of the central processor section. It will be appreciated by those skilled in the art that controller 106 can also be implemented using a variety of separate dedicated or programmable integrated or other electronic circuits or devices, such as hardwired electronic or logic circuits including discrete element circuits or programmable logic devices, such as PLDs, PALs, PLAs or the like. The controller 106 can also be implemented using a suitably programmed general-purpose computer, such as a microprocessor or microcontrol, or other processor device, such as a CPU or MPU, either alone or in conjunction with one or more peripheral data and signal processing devices. In general, any device or similar devices on which a finite state machine capable of implementing the flow charts, can be used as the controller 106. In a particular embodiment, the controller 106 can be a data acquisition system located in the vicinity of the sensors in a power plant, thereby providing a remote access system, as embodied by the invention.

FIG. 2 illustrates the features that are used in the system 100, as embodied by the invention, in use to detect and monitor elements. In the context of the invention herein, the elements being monitored and detected can be those of a turbo-machine, for example, but not limited to, blades of a rotating machine, such as but not limited to, a gas turbine, steam turbine, compressor, wind turbine, hydro turbine, aero-derivative turbine or the like. Hereinafter, the description of the invention will refer to a blade and associated elements as the element to be monitored and detected, however that recitation is not intended to limit the invention in any manner.

The signal processor 103, as embodied by the invention, will extract and send to feature extractor 104 at least two properties of the blade tip for each blade 202, as it passes under the sensors 102. These properties or output 107 include, but are not limited to, the circumferential offset of at least one of the leading or trailing edge from a nominal position, the average of the leading and trailing edges, and radial clearance between the blade tip 201 and casing 203 (the turbine components are illustrated schematically for illustration purposes) from the sensor 102.

Using this information, several features can be computed as output 107, as embodied by the invention. For example, the features include static blade tip bending, blade untwist, blade radial extension, and blade tip vibratory amplitudes and frequencies. These features can be indications of the condition or “health” of a blade (or other monitored element), where the health can be analyzed, processed, or otherwise used to determine the condition of the blade. For example, and not intended to limit the invention in any manner, the indication in a blade may represent a bend, crack, or missing section, the indications having been caused by foreign object damage (FOD), low and high-cycle fatigue or corrosion on a blade 202.

Furthermore, other complex time, and frequency domain analyses can be conducted by the system 100. For example, through appropriate analysis, such as but not limited to, known algorithms and processing, including without limitation Fourier analysis, finite element analysis, fracture mechanics algorithms, 3-D analysis, and the like, can yield static deflection and dynamic deflection properties, such as blade tip vibratory amplitudes and frequencies.

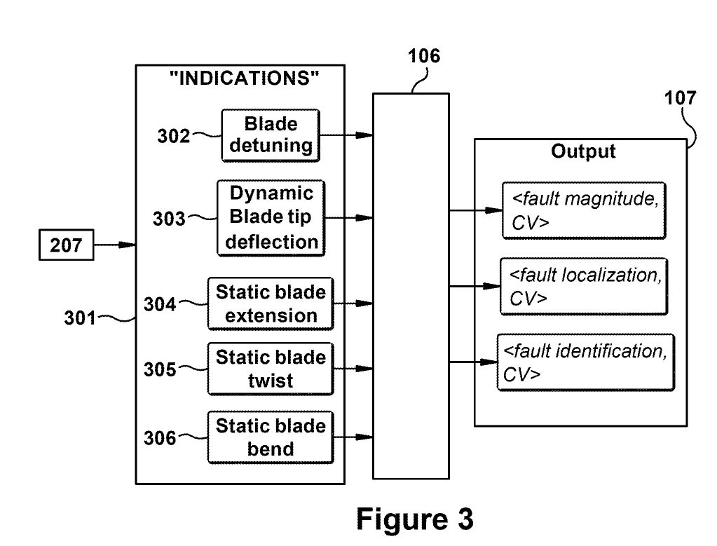

Output 107 can be extracted and used to provide diagnostic outputs, such as a designation of an “indication” 301 for a blade 202 at progressively different, such as increasing, levels of specificity. The indication, as embodied by the invention, can comprise, but is not limited to, a blade fault, including the detuning 302 of the blade 202; blade tip deflection 303, such as but not limited to, dynamic tip deflection; blade extension 304, such as but not limited to, static blade extension; blade twist 306, such as but not limited to, static blade twist; and blade bend 307, such as but not limited to, static blade bend; or combinations thereof. As embodied by the invention, the indications or other features extracted above can be used to provide diagnostic outputs by applying diagnostic algorithms in controller 106 to provide the levels of diagnostic outputs. This feature of the system 100 is illustrated in FIG. 3.

In FIG. 3, the blade health monitoring system 100, as embodied by the invention, can output an indication or “basic” output that comprises an indication of whether or not a blade is in a “fault” condition to the controller 106, which in turn provides system output 107. At another level, as embodied by the invention, an output can comprise provision of a location of the “indication.” Further, the system 100 can, at a relative complex indication, comprise an output including a provision of the magnitude of the determined indication.

For each system output 107 (hereinafter “output”), the blade health monitoring system 100, as embodied by the invention, can provide an associated confidence value, which can be assigned to the diagnostic output 107. The confidence value is based on an aggregation approach as described hereinafter.

The diagnostic output and associated confidence value, as embodied by the invention, in the blade health monitoring system 100 can be implemented at at least two levels. A first level is a data based approach. In the data based approach, as embodied by the invention, extracted output is trended over time, and statistically significant changes are identified or flagged as possible indications of an “anomalous” blade condition. A second level for the output confidence value and associated diagnostic output value, as embodied by the invention's system 100, incorporates a model-based fault diagnosis and feature aggregation capability. This model-based fault diagnosis and feature aggregation comprises comparing a feature value with an expected value for that feature from a previously stored, predetermined, or an a priori model of a blade 202. If the feature magnitudes match within a pre-defined, predetermined margin of error, an indication can be provided. The model predictions may be used as a guideline for relative deflections that can be expected in various static and dynamic vibratory modes of a turbine, or a turbine blade 202.

Feature aggregation, as embodied by the invention, refers to a progressive accumulation of evidence from simple to complex, supported by a priori knowledge from models and laboratory tests. These can provide a confidence value associated with the diagnostic announcement. The confidence value of a diagnostic increases as the number of supporting fault related indications for a give blade increase, thereby reducing the probability of a false alarm. This methodology can allow for flexibility in the configuration and processing of sensors 102 of the blade health monitoring system 100, as embodied by the invention. As the blade health monitoring system 100 is developed with more knowledge of blade diagnostics, more features and historical trends of those feature scan be stored in the central system or logic 101 and can be generated from the same sensor data. Additionally, these features can be generated from the same sensor data and can be added into the aggregation process, to provide even more enhanced confidence in the blade health diagnosis, as embodied by the invention. At enhanced levels of the feature aggregation hierarchy as embodied by the invention, a priori knowledge from field investigations of failed blades, as well as finite element models, can be used to determine whether or not a feature value is valid. Therefore, the aggregation of the blade health monitoring system 100, as embodied by the invention, does not accept feature values that could be interpreted as outliers.

The blade health monitoring system 100, as embodied by the invention, can also have the capability to remotely monitor the health of the article or machine, as illustrated in FIG. 1 with the remote access of the central system or logic 101 with the controller 106. Further, the blade health monitoring system 100, as embodied by the invention, can also by periodically or continuously transferring data to a central system or logic 101, where further analysis for blade health monitoring can be performed.

While the invention has been described in terms of various specific embodiments, those skilled in the art will recognize that the invention can be practiced with modification within the spirit and scope of the claims.

What is claimed is:

1. A system for monitoring a condition of an article, the system comprising:
a controller;
at least one sensor for detecting a characteristic of an article;
a signal processor for processing signals from the at least one sensor;
a feature extractor that can extract at least one of a range of article conditions from the output from the signal processor and that can evaluate at least one of a range of article conditions, the feature extractor providing feature extractor output to the controller;
an operation detector receiving data of detected features of the elements being monitored, the operation detector providing output to the controller; and
a central system for storing historical data about the condition of an article, the off-fine processor providing output to the controller;
wherein the controller analyzes the output from the feature extractor, the operation detector, and the central system to provide a system output of the condition of the article being monitored.

2. A system according to claim 1, wherein the system output can comprise output provided in a hierarchical output from simple to complex output.

3. A system according to claim 2, wherein the hierarchical output from simple to complex output comprises output of increasing levels of confidence in the system output.

4. A system according to claim 1, the article comprises a turbo-machine.

5. A system according to claim 4, the turbomachine comprises a gas turbine, steam turbine, compressor, wind turbine, hydro turbine, or an aero-derivative turbine.

6. A system according to claim 5, wherein the at least one of a range of article conditions comprise detected features, the detected features comprise at least one of a blade fault, detuning of a blade; blade tip deflection, dynamic tip deflection; blade extension, static blade extension; blade twist, static blade twist; blade bend, static blade bend; and combinations thereof.

7. A system according to claim 5, wherein the at least one of a range of article conditions comprise detected features, the detected features comprise at least one of static blade tip bending, blade untwist, blade radial extension, and blade tip vibratory amplitudes and frequencies, and combinations thereof.

8. A system according to claim 5, wherein the at least one of a range of article conditions comprise detected features, the detected features comprise at least one of a leading edge and trailing edge of a blade.

9. A system according to claim 8, wherein from a nominal position can determine a circumferential offset of the at least one of a leading edge and trailing edge of a blade from a nominal position.

10. A system according to claim 1, the at least one sensor able to detect at least one indication on the article, the at least one indication capable of providing details of the condition of the article.

11. A system according to claim 10, wherein the at least one indication comprises at least one of freckle, defect, cracks, and inclusion, and combinations thereof.

12. A system according to claim 1, the system comprising algorithms and processing of the system output.

13. A system according to claim 12, wherein the algorithms and processing of the system output comprise at least one of Fourier analysis, finite element analysis, fracture mechanics algorithms, 3-D analysis, and combinations thereof.

14. A system according to claim 1, wherein the system output of the condition of the article being monitored comprises hierarchical output.

15. A system according to claim 1, wherein blade health monitoring system remotely monitors the article by at least one of periodically and continuously transferring data to the central system, where further analysis for blade health monitoring system can be performed.

16. A method for monitoring a condition of an article, the method comprising:
providing a controller;
detecting a characteristic of an article;
processing signals detected of the characteristic of an article;
extracting at least one of a range of article conditions from the output from the processed signal and evaluating at least one of a range of article conditions;
providing feature extractor output to the controller;
receiving data of detected features of the elements being monitored, the operation detector providing output to the controller;
storing historical data about the condition of an article;
providing the historical data about the condition of an article and providing the historical data about the condition of an article output to the controller; and
the method further comprising outputting a condition of the article being monitored.

17. A method according to claim 16, wherein outputting comprises outputting hierarchal conditions of the article.

18. A method according to claim 16, wherein the article comprises a turbo-machine, the turbo machine comprises at least one of a gas turbine, steam turbine, compressor, wind turbine, hydro turbine, or an aero-derivative turbine.

19. A method according to claim 17, wherein the at least one of a range of article conditions comprise detected features, the detected features comprise at least one of a blade fault, detuning of a blade; blade tip deflection, dynamic tip deflection; blade extension, static blade extension; blade twist, static blade twist; blade bend, static blade bend; and combinations thereof.

20. A method according to claim 17, wherein at least one of a range of article conditions comprise detected features, the detected features comprise at least one of static blade tip bending, blade untwist, blade radial extension, and blade tip vibratory amplitudes and frequencies, and combinations thereof.
